(19) United States
(12) Patent Application Publication
(10) Pub. No.: US 2021/0336451 A1
(43) Pub. Date: Oct. 28, 2021

(54) BATTERY STRESS RELIEF SYSTEM

(71) Applicant: Yazaki North America, Inc., Canton, MI (US)

(72) Inventors: Yuanyuan Wu, Manchester, MI (US); Kenneth John Russel, South Lyon, MI (US)

(21) Appl. No.: 17/240,113

(22) Filed: Apr. 26, 2021

Related U.S. Application Data
(60) Provisional application No. 63/016,084, filed on Apr. 27, 2020.

(51) Int. Cl. H02J 7/00; B60L 53/10; B60L 3/04

(52) U.S. Cl. CPC H02J 7/0029; H02J 7/0045; B60L 3/04; B60L 53/10; H02J 7/007

(57) ABSTRACT

A charge system for a vehicle includes a battery charge path, a current limiting element, and a capacitor. The current limiting element is arranged in series along the battery charge path, and in parallel relative to the capacitor. During an inrush event, the current limiting element is configured to initially restrict current flow between the battery and the load, increasing the rate and amount with which the capacitor is used to meet the current demands of the load. Thus, the current limiting element allows the battery to gradually increase its supply of current to the load in a manner that does not jeopardize its health. Once a steady state level of charging has been reached, the current limiting element is able to reduce its resistance to current flow, and the battery is able to safely take over as the primary source of current to the load.

### CROSS-REFERENCE TO RELATED APPLICATION

This application claims priority to, and the benefit of the filing date of U.S. Provisional Patent Application No. 63/016,084, filed Apr. 27, 2020, the entire disclosure of which is incorporated herein by reference in its entirety.

### BACKGROUND

Rapid charge and discharge events adversely affect the health of a battery, particularly when they occur during the use of the battery with a high power load. Such inrush events may occur, for example, as a result of sudden demands from a load (such as, e.g., upon initially establishing electrical contact between the battery and a load) or as a result of sudden flow of current to the battery during recharging.

Battery stress may be of particular concern for an electric vehicle (EV), given the high power demands of the main battery and frequent exposure of the battery to inrush events (e.g. acceleration of the EV, regenerative braking, etc.) during the operation. Reduced battery performance and capacity may cause reduced vehicle performance, eventually leading to early and potentially costly battery replacement.

### SUMMARY

According to one implementation of the present disclosure, a charge system for a vehicle includes a battery charge path, a current limiting element, and a capacitor charge path. The battery charge path includes a first end for electrical connection to a battery and a second end for electrical connection to a load. The current limiting element is arranged in series along the battery charge path. The capacitor charge path includes a first end comprising an input terminal for electrical connection to a capacitor and a second end that is electrically coupled to the battery charge path at a location between the current limiting element and the second end of the battery charge path. During a first phase of operation, the current limiting element is configured to provide a first degree of resistance to current flow between the first end of the battery charge path and the second end of the battery charge path. During a second phase of operation the current limiting element is configured to provide a second degree of resistance to current flow between the first end of the battery charge path and the second end of the battery charge path that is less than the first degree of resistance.

The change in resistance is optionally effectuated without the application of an external control input signal to the current limiting element. For example, the current limiting element comprises a thermally sensitive element, such as, e.g., a negative temperature coefficient thermistor.

According to another implementation of the present disclosure, a battery fuse terminal for a vehicle includes a housing securable relative to a battery exterior. A battery attachment element and a current limiting element are supported by the housing. A first conductive element extends between and electrically couples the battery attachment element to the current limiting element. The battery fuse terminal further includes a first electrical connector configured to engage a power terminal of an external device. A second conductive element extends between and electrically couples the current limiting element and the first electrical connector. A second electrical connector configured to engage a terminal coupled to a capacitor is electrically coupled to the second conductive connector element such that the second electrical connector is arranged in parallel with the first electrical connector.

During a first phase of operation, the current limiting element provides a first degree of resistance to current flow between the terminal of the battery and the first electrical connector. During a second phase of operation, the current limiting element provides a second degree of resistance to current flow between the terminal of the battery and the first electrical connector. The change in resistance provided by the current limiting element is optionally effectuated without the application of an external control input signal to the current limiting element. The current limiting element optionally comprises a negative temperature coefficient resistor. The first conductive element and battery attachment element are optionally connected via a fusible link.

According to another implementation of the present disclosure, a method for charging a load includes causing current from a battery to flow through a current limiting element located to a load and causing current to flow from a capacitor located in parallel to the current limiting element to the load. During a first phase, the current limiting element is defined by a first resistance. During a second phase, the current limiting element is defined by a second resistance that is less than the first resistance. The change in the resistance of the current limiting element is optionally effectuated without the application of an external control input signal thereto. For example, the current limiting element may include a thermally sensitive element.

Current flow from the battery is optionally used to charge the capacitor during the second phase. An amount of current flow from the capacitor to the load is greater than an amount of current flow from the battery to the load during the first phase. A rate of current flow to the load from the battery increases over time. According to various embodiments, current flow between the battery and the load is substantially prevented by the current limiting element during the first phase. Current flow between the battery and the load is optionally substantially unrestricted by the current limiting element during the second phase.

The current limiting element optionally transitions from being defined by the first resistance to being defined by the second resistance responsive to a change in a core temperature of the current limiting element. For example, the change in resistance of the current limiting is responsive to a core temperature of the current limiting element exceeding a threshold temperature range. The current limiting element may include a negative temperature coefficient thermistor.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a diagram of a charge system, according to one embodiment.

FIG. 2 is an example graph illustrating the resistance value of a thermally sensitive element with respect to temperature, according to one embodiment.

FIG. 3 is an example graph comparing current flow form the components of a charging system and a charge system, according to one embodiment.

FIG. 4 is a circuit diagram of a high power vehicle system utilizing a charge system, according to one embodiment.

FIG. 5 illustrates a battery fuse terminal incorporating a charge system, according to one embodiment.

FIG. 6 illustrates a power pack system incorporating a charge system, according to one embodiment.

### DESCRIPTION

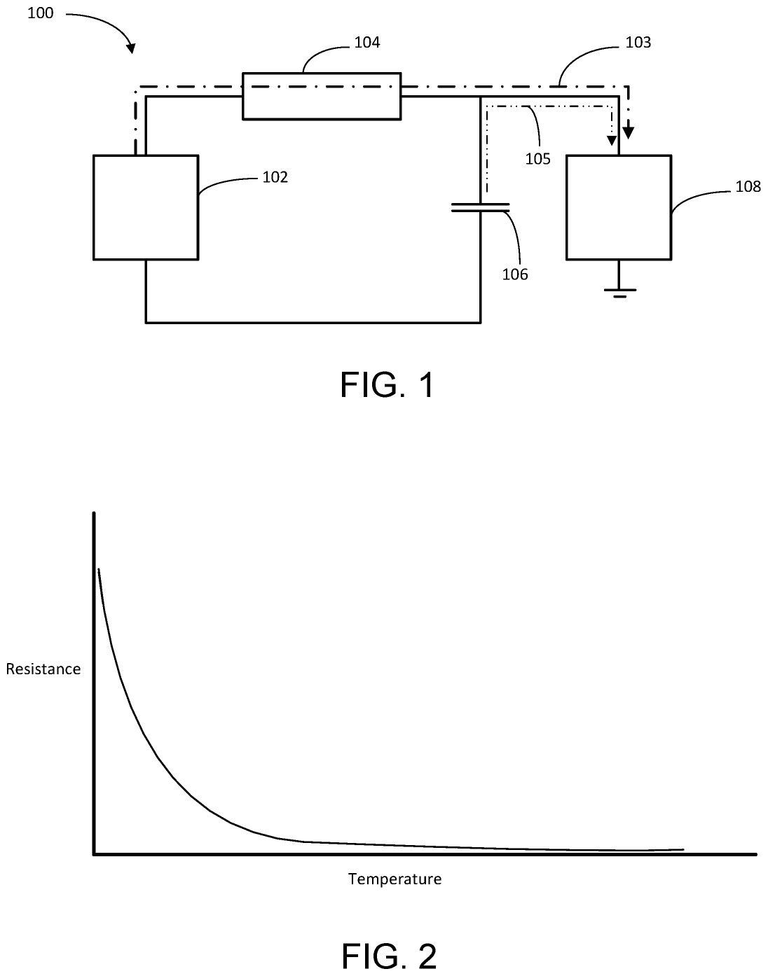

Referring generally to the FIGURES, a hybrid charge system 100 for relieving battery stress is shown and described according to various embodiments. As shown in FIG. 1, the charge system 100 includes a battery 102 and a capacitor 106 arranged in parallel. A battery charge path 103 connects the battery to a load 108, and a capacitor charge path 105 connects the capacitor 106 to the load 108, as well as to the battery 102.

The internal resistance of capacitors is typically relatively low, which allows capacitors to respond quickly to inrush events. Thus, the arrangement of the capacitor 106 and battery 102 of the charge system 100 in series allows the capacitor 106 to provide current during an inrush event (e.g., upon initially establishing electrical contact between the charge system 100 and the load 108), allowing the battery 102 to gradually increase current as the load 108 reaches a steady state level of charging. Once a steady state level of charging has been reached, the battery 102 takes over as the primary source of current to the load 108.

The rate at which current flow to the load 108 is provided by the battery 102 and capacitor 106, individually, depends on the difference between the effective resistance of the battery charge path 103 and the effective resistance of the capacitor 106. In a circuit consisting of only a capacitor and battery, the effective resistance of the battery charge path will correspond to the internal resistance of the battery, and the effective resistance of the capacitor will correspond to the internal resistance of the capacitor. Thus, if the difference between an internal resistance of the battery and an internal resistance of the capacitor is small, the battery may still provide a signification portion (e.g., approximately half) of the current to the load during an inrush event. Depending on the power needs of the load, this reduction to current flow from the battery during the inrush event may be insufficient to protect it from damage.

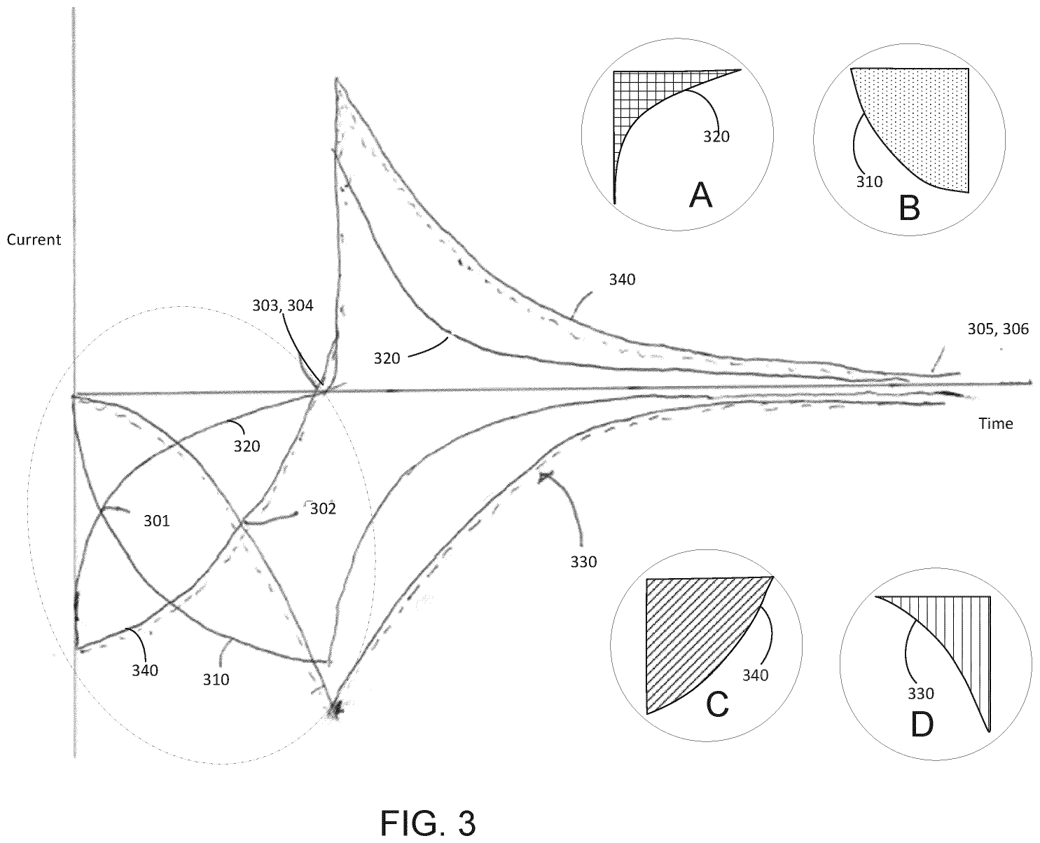

In contrast to a battery, a capacitor incurs minimal wear and degradation when subject to inrush currents. Accordingly, as shown in FIG. 1, the charge system 100 additionally includes a current limiting element 104 that increases the effective resistance of the battery charge path 103 relative to the effective resistance of the capacitor 106. As described with reference to FIG. 3 below, the current limiting element 104 thus increases the rate and amount with which the capacitor 106 is used to meet the current demands of the load 108—and thereby limits the rate and amount of current drawn from the battery 102—during an inrush event. By extending the time during which the capacitor 106 is utilized as the primary source of current to the load 108 during an inrush event, the current limiting element 104 advantageously allows the battery 102 to gradually increase its supply of current to the load 108 in a manner that does not jeopardize its health. Once a steady state level of charging has been reached, the battery 102 is able to safely take over as the primary source of current to the load 108.

The current limiting element 104 may be defined by a variety of different resistive elements. For example, according to some embodiments, the current limiting element 104 comprises a resistor (e.g., a thick film, a thin film, a wirewound arrangement, carbon composite, etc.) having a fixed resistance value. As a resistor does not require any additional components or external control input signals for its operation, a resistor allows the current limiting 104 device to be easily and cost-effectively incorporated into the charge system 100.

Although the resistance provided by a current limiting element 104 comprising a resistor is advantageous during inrush events, the continued restriction to current flow between the battery 102 and load 108 is often undesirable during steady state charging conditions. Accordingly, in other embodiments, the current limiting element 104 alternatively comprises an active element having a resistance that is variable responsive to an external control input signal (received via, e.g., controller, manual adjustment, etc.). Examples of such active elements include rheostats, potentiometers, digital resistors, a field effect transistor operating in a linear mode, etc.

By allowing the effective resistance of the battery charge path 103 to be decreased following an inrush event, a current limiting element 104 comprising an active element advantageously increases the efficiency and speed with which the battery 102 may supply current to the load 108 under steady state charging conditions. However, the increased number of components, complexity, and costs associated with incorporating the external input source required for the operation of an active element may limit the suitability of the use of an active element as a current limiting element 104 in various situations.

According to various embodiments, the current limiting element 104 advantageously comprises a thermally sensitive element (e.g., a negative temperature coefficient thermistor) that varies in a predictable manner responsive to changes in temperature. As representatively depicted by the graph of FIG. 2, a current limiting element 104 comprising a thermally sensitive element has a large resistance at an initial, low temperature. Upon a core temperature of the thermally sensitive element increasing to a threshold temperature range, the resistance value of the thermally sensitive element decreases non-linearly (e.g., exponentially). Once the core temperature has exceeded the threshold temperature range, the thermally sensitive element operates in a steady state flow state in which the thermally sensitive element provides only a minimal (e.g., no) resistance to current flow to the load 108 from the battery 102.

The increase in the core temperature of the current limiting element 104 comprising a thermally sensitive element may occur as a result of heat that is dissipated through the thermally sensitive element during current flow. The increase in core temperature of the thermally sensitive element may also occur as a result of changes in ambient temperature. For example, the core temperature of the thermally sensitive element may increase as a result of the heat generated by the load 108 or other components of the charge system 100 during operation. According to some embodiments, the thermally sensitive element is optionally connected to the load 108 via a heat sink, so as to increase the responsiveness of the thermally sensitive element to changes in ambient temperature.

The initial resistance of the thermally sensitive element and the threshold temperature range at which the thermally sensitive element reaches the steady state flow state vary based on the construction of the thermally sensitive element. Accordingly, by selecting a thermally sensitive element suited to the operating parameters and conditions of the load 108 with which the charge system 100 is used, a current limiting element 104 comprising a thermally sensitive element is able to provide the benefits of both a fixed resistance resistor and an active element—while avoiding the limitations of each of these options.

Namely, similar to a current limiting element 104 comprising an active element, a current limiting element 104 comprising a thermally sensitive element is able to provide varying degrees of resistance to current flow, thus allowing the effective resistance of the battery charge path 103 to be decreased following an inrush event. However, in contrast to an active element, the thermally sensitive element does not require the receipt of an external control input signal, but rather varies its resistance passively responsive to changes in temperature. Similar to a current limiting element 104 comprising a resistor, this lack of any need for additional components or external control components thus allows a current limiting element 104 comprising a thermally sensitive element to be easily and cost-effectively incorporated into the charge system 100.

Shown in FIG. 3 is a graph illustrating the flow of current from a battery and a capacitor of a charging system which does not include a current limiting element 104, and a charge system 100 that includes a current limiting element 104 comprising a thermally sensitive element during an inrush event. The first curve 310 illustrates a time response curve of the current flow from the battery of the charging system. The second curve 320 illustrates a time response curve of current flow to and from the capacitor of the charging system. The third curve 330 illustrates a time response curve of current flow from the battery 102 of the charge system 100. The fourth curve 340 illustrates a time response curve of the current flow to and from the capacitor 106 of the charge system 100.

As illustrated by the graph of FIG. 3, in both the charging system (which does not include a current limiting element 104) and the charge system 100 (which comprises a current limiting element 104 including a thermally sensitive element), the capacitor is the primary source of current at the initiation of an inrush event. As the capacitor becomes increasingly depleted and the battery increases its discharge of current, an equilibrium point 301, 302 is reached. The equilibrium point 301, 302 corresponds to the time at which time the amount of current supplied by the capacitor is equal to the current supplied by the battery. Following the occurrence of the equilibrium point 301, 302, the amount of current supplied by the battery begins to exceed the current provided by the capacitor. The capacitor continues to supply current to the load until it reaches a transition point 303, 304. Following the occurrence of the transition point 303, 304, the capacitor stops supplying current to the load, and instead begins receiving current from the battery (evidenced by the positive current value of current flow for the capacitor). The battery continues supplying current to the battery and capacitor until a recharge point 305, 306 is reached, which corresponds to a time at which the capacitor has been recharged by the battery. After the recharge point 305, 306 the current discharged by the battery attains a steady state of flow to the load.

As shown by the graph of FIG. 3, the charging system (which does not include a current limiting element 104) and the charge system 100 (which comprises a current limiting element 104 including a thermally sensitive element) each achieve a respective transition point 303, 304 and recharge point 305, 306 at similar time. Accordingly, as the incorporation of the current limiting element 104 in the charge system 100 does not adversely affect the time required to recharge the capacitor 106 by the battery 102 following an inrush event.

However, as shown by a comparison of the first curve 310 against the third curve 330, in the absence of a current limiting element 104 to increase an effective resistance of flow between the battery 102 and load 108, the rate of current from the battery of the charging system—which does not include a current limiting element 104—is significantly greater than the rate of current flow from the battery 102 of the charge system 100. Thus, as illustrated by the comparison of the second curve 320 against the fourth curve 340, the amount of current supplied by the capacitor of the charging system is much lower than the amount of current supplied by the capacitor 106 of the charge system 100. As a result in these changes in the rates at which current is supplied between the capacitor and battery components of the charging system and charge system 100, the charging system reaches its equilibrium point 301 much sooner than the charge system 100 reaches its equilibrium point 302.

Thus, as illustrated by the call-outs of FIG. 3, when comparing the amount of energy supplied individually by the capacitor and battery of each of the charging system and charge system 100—which is represented by the area underneath each curve between the start of the inrush event and the occurrence of the transition point 303, 304—the amount of energy supplied by the capacitor of the charging system (see call-out A) is substantially less than the energy supplied by the battery of the charging system (see call-out B). In contrast, the amount of energy supplied by the capacitor 106 of the charge system 100 (see call-out C) is substantially greater than the energy supplied by the battery 102 of the charge system 100 (see call-out D). Accordingly, as illustrated by a comparison of the call-out B of the first curve 310 against the call-out D of the third curve 330, the energy demands on the battery 102 of the charge system 100 (which includes a current limiting element 104) are significantly less than those on the battery of the charging system which does not include a current limiting element 104.

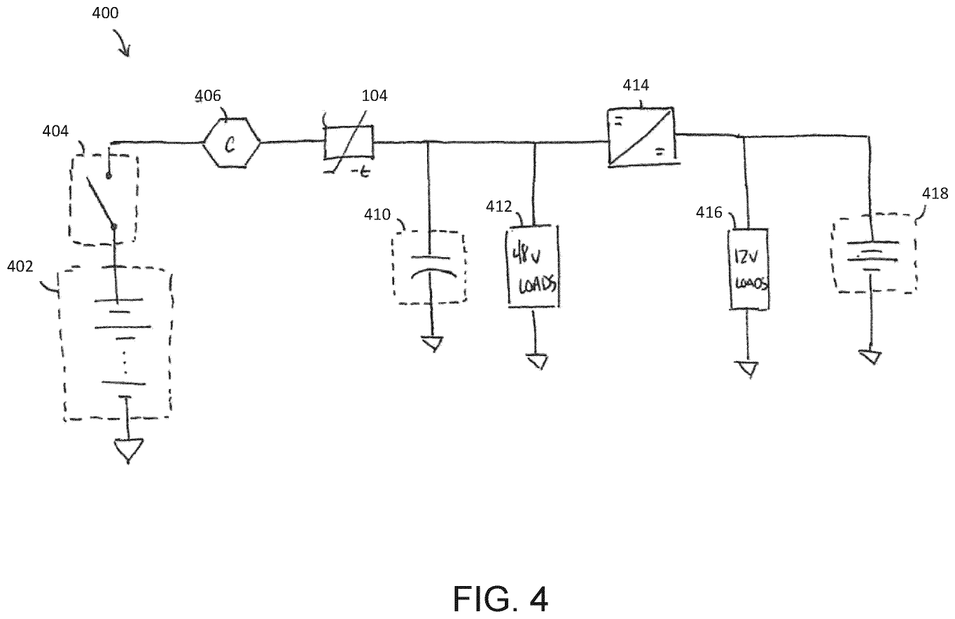

Given the high power demands of an electric vehicle (“EV”), according to various embodiments, the hybrid charge system 100 is advantageously incorporated into an EV power system. Referring to FIG. 4, a high voltage power circuit 400 utilizing a charge system 100 as described according to any embodiment above to supply current to one or more high voltage loads 412 (e.g., 48V loads) such as, e.g., an electromechanical anti-role control (EARC), an electrified turbo (E-Turbo), a belt starter-generator (BSG), etc. of an EV is shown, according to one example embodiment.

A contactor 404 and/or a current sensor 406 are optionally arranged in series with the primary battery 402 of the EV. The contactor 404 may comprise any electronic or electromechanical device that disconnects battery 402 from the remainder of circuit 400. For example, contactor 404 is a relay, contactor, or other switch that is manually or automatically configurable to allow or prevent current flow from/to battery 402. The contactor 404 is optionally controlled by a control circuit (not shown) to provide thermal protection, over-voltage protection, under-voltage protection, or other protections to circuit 400. The contactor 404 may optionally be replaced (or supplemented) with a fuse or other protection device.

The optional current sensor 406 measures current flow from/to the battery 402. Current sensor 406 may monitor charge and discharge rates, and other parameters that may affect the health or condition of the battery 402. In some embodiments, current sensor 406 may also be connected to the optional control circuit used to operate the contactor 404 based on measured current flow from, and to, battery 402.

An optional DC-DC converter 414 steps-down the power provided by battery 402 and/or supercapacitor 410. The stepped down power may be used for lower-demand components 616 of the EV, such as e.g., head lights, power windows, a radio, or other components of the EV and/or to recharge a lower power battery 418 (e.g., a 12V battery).

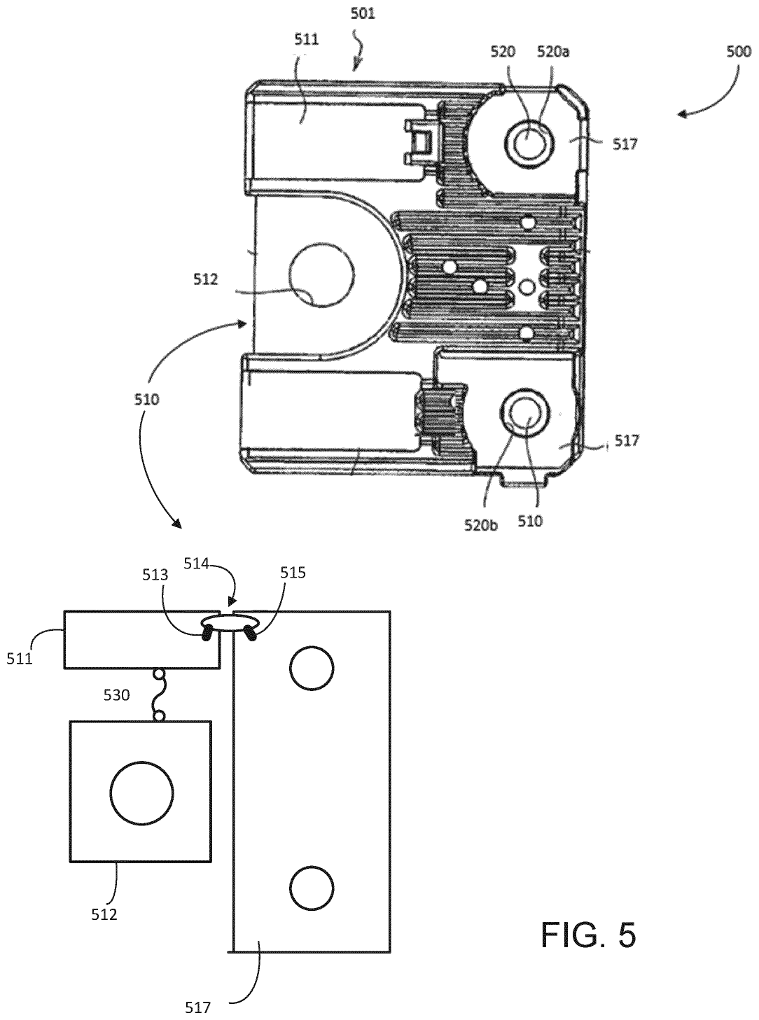

A charge system 100 described according to any embodiment herein may be electrically connected to the battery 402 and supercapacitor 410 of the high voltage power circuit 400, according to any number of different arrangements, configurations, etc. For example, as representatively shown in FIG. 5, in some embodiments the charge system 100 is integrated into the high voltage power circuit 400 via battery fuse terminal (“BFT”) 500.

As representatively shown in FIG. 5, the battery fuse terminal 500 generally includes a housing 501 that is securable relative to the battery 402 of the vehicle. The specific structure and design of the housing 501 may vary as needed. An electrical distribution arrangement 510 is supported by the housing 501. The electrical distribution arrangement 510 includes various elements via which current from the battery 402 is directed to one or more electrical connectors 520 (e.g., studs, box-like connectors, etc.) that are configured to engage the terminals of one or more components (e.g. supercapacitor 410, load 412, DC-DC converter 414, etc.) of the vehicle.

For example, as shown in FIG. 5, the electrical distribution arrangement 510 optionally includes a first electrically conductive element 511 (e.g., a bus bar structure or lead frame) that is electrically coupled to a battery attachment element 512 that is mechanically and electrically configured to engage a positive terminal of the battery 402 to which the housing 501 is attached. A first leg 513 of a current limiting element component 514 (e.g., a thermally sensitive element) is mechanically and electrically connected (e.g., soldered) to the first electrically conductive element 511. A second leg 515 of the current limiting element component 514 is mechanically and electrically connected (e.g., soldered) to a second electrically conductive element 517 (e.g., a bus bar structure or lead frame). A first electrical connector 520a configured to engage a power terminal of the load 412 and a second electrical connector 520b configured to engage a terminal of the supercapacitor 410 are electrically coupled to the second conductive element 517.

Fusible links 530 are optionally used to electrically and mechanically couple various elements of the electrical distribution arrangement 510 to one another. For example, as shown in FIG. 5, a fusible link 530 extends between and mechanically and electrically couples the first conductive element 511 to the battery attachment element 512.

As will be appreciated, any other number of different components, configurations and arrangements may be used to electrically couple the components of the charge system 100 using a BFT 500. Also, although the BFT 500 is shown including a single current limiting element component 514, the BFT 500 may optionally include any number of additional current limiting element component 514.

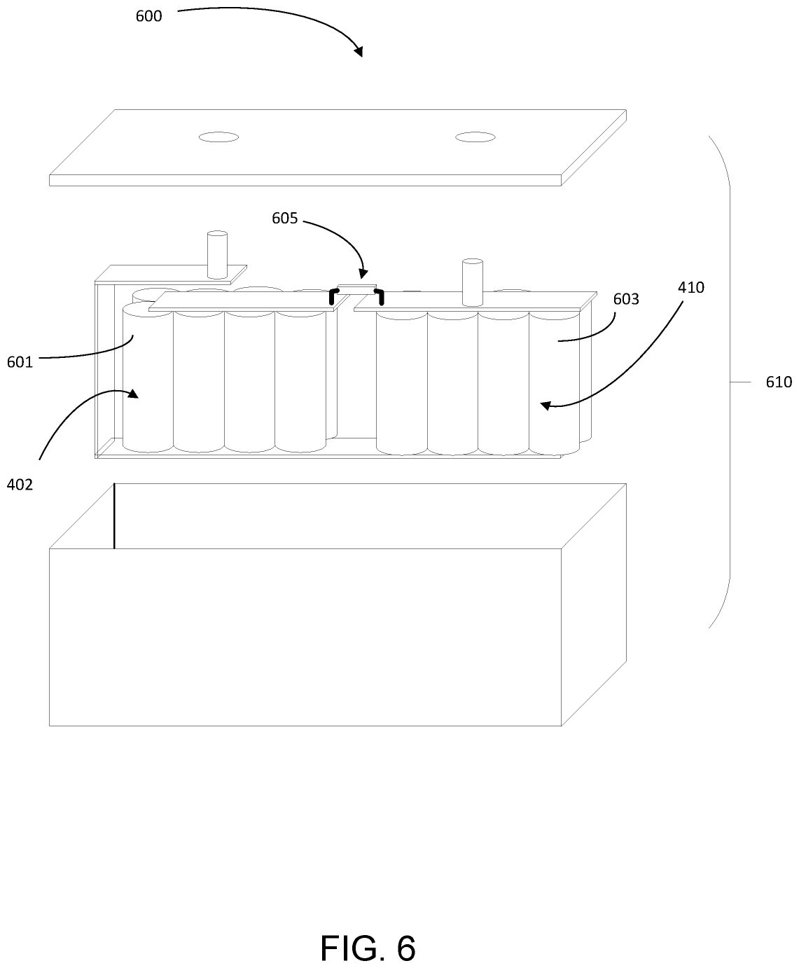

Referring to FIG. 6, according to some embodiments, the battery 402 and supercapacitor 410 optionally define a hybrid power pack system 600. Battery cells 601 that form the battery 402 and capacitive components 603 that form the supercapacitor 410 are supported within a power pack housing 610. In such embodiments, a current limiting element component 605 (e.g., a thermally sensitive element) connects the battery cells 601 and capacitive components 603, and is also supported with the power pack housing 610. In such embodiments, the hybrid power pack system 600 may be directly coupled to a load (e.g., a high voltage load 412), without the need for the connection or wiring of any additional components thereto. In some such embodiments, the power pack system 600 also optionally includes additional components (e.g., a contactor, a fuse, etc.) that are also supported within the power pack housing 610.

As used herein, the terms “about” and “approximately” will be understood by persons of ordinary skill in the art and will vary to some extent depending upon the context in which they is used. If there are uses of these terms which are not clear to persons of ordinary skill in the art, given the context in which it is used, “about” and “approximately” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

While certain embodiments have been illustrated and described, it should be understood that changes and modifications may be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations may be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions, or biological systems, which can of course vary. It is also to be understood that the terminology used herein is for the purpose of describing particular embodiments only and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range may be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like, include the number recited and refer to ranges which may be subsequently broken down into subranges as discussed above. Finally, as will be understood by one skilled in the art, a range includes each individual member.

Other embodiments are set forth in the following claims.

What is claimed is:

1. A charge system for a vehicle, the charge system comprising:
a battery charge path having a first end for electrical connection to a battery and a second end for electrical connection to a load;
a current limiting element arranged in series along the battery charge path; and
a capacitor charge path having a first end comprising an input terminal for electrical connection to a capacitor and a second end that is electrically coupled to the battery charge path at a location between the current limiting element and the second end of the battery charge path;
wherein, during a first phase of operation, the current limiting element is configured to provide a first degree of resistance to current flow between the first end of the battery charge path and the second end of the battery charge path, and during a second phase of operation the current limiting element is configured to provide a second degree of resistance to current flow between the first end of the battery charge path and the second end of the battery charge path that is less than the first degree of resistance.

2. The charge system of claim 1, wherein the change in resistance is effectuated without the application of an external control input signal to the current limiting element.

3. The charge system of claim 1, wherein the current limiting element comprises a thermally sensitive element.

4. The charge system of claim 3, wherein the current limiting element comprises a negative temperature coefficient thermistor.

5. A battery fuse terminal for a vehicle, the battery fuse terminal comprising:
a housing securable relative to a battery exterior;
a battery attachment element supported by the housing;
a current limiting element supported by the housing;
a first conductive element extending between, and electrically coupling, the battery attachment element to the current limiting element;
a first electrical connector configured to engage a power terminal of an external device;
a second conductive element extending between, and electrically coupling, the current limiting element and the first electrical connector; and
a second electrical connector configured to engage a terminal coupled to a capacitor, the second electrical connector being electrically coupled to the second conductive connector element such that the second electrical connector is arranged in parallel with the first electrical connector.

6. The battery fuse terminal of claim 5, wherein, during a first phase of operation, the current limiting element is configured to provide a first degree of resistance to current flow between the terminal of the battery and the first electrical connector, and during a second phase of operation the current limiting element is configured to provide a second degree of resistance to current flow between the terminal of the battery and the first electrical connector.

7. The battery fuse terminal of claim 6, wherein the change in resistance provided by the current limiting element is effectuated without the application of an external control input signal to the current limiting element.

8. The battery fuse terminal of claim 7, wherein the current limiting element comprises a negative temperature coefficient resistor.

9. The battery fuse terminal of claim 5, wherein the first conductive element and battery attachment element are connected via a fusible link.

10. A method for charging a load, comprising:
causing current from a battery to flow through a current limiting element to a load;
causing current to flow from a capacitor to the load, wherein the capacitor is located in parallel to the current limiting element;
wherein, during a first phase, the current limiting element is defined by a first resistance and during a second phase, the current limiting element is defined by a second resistance that is less than the first resistance.

11. The method of claim 10, wherein the change in the resistance of the current limiting element is effectuated without the application of an external control input signal thereto.

12. The method of claim 10, wherein the current limiting element comprises a thermally sensitive element.

13. The method of claim 10, wherein current flow from the battery is used to charge the capacitor during the second phase.

14. The method of claim 10, wherein an amount of current flow from the capacitor to the load is greater than an amount of current flow from the battery to the load during the first phase.

15. The method of claim 10, wherein a rate of current flow to the load from the battery increases over time.

16. The method of claim 10, wherein current flow between the battery and the load is substantially prevented by the current limiting element during the first phase.

17. The method of claim 16, wherein current flow between the battery and the load is substantially unrestricted by the current limiting element during the second phase.

18. The method of claim 17, wherein the current limiting element transitions from being defined by the first resistance to being defined by the second resistance responsive to a change in a core temperature of the current limiting element.

19. The method of claim 18, wherein the change in resistance of the current limiting is responsive to a core temperature of the current limiting element exceeding a threshold temperature range.

20. The method of claim 19, wherein the current limiting element comprises a negative temperature coefficient thermistor.
